(19) United States
(12) Patent Application Publication
(10) Pub. No.: US 2025/0110146 A1
(43) Pub. Date: Apr. 3, 2025

(54) SENSOR MEMBER AND METHOD FOR MANUFACTURING SENSOR MEMBER

(71) Applicant: Sumitomo Wiring Systems, Ltd., Yokkaichi-Shi (JP)

(72) Inventors: Takashi NISHIGUCHI, Yokkaichi-Shi (JP); Toshinari KOBAYASHI, Yokkaichi-Shi (JP); Moriyuki SHIMIZU, Yokkaichi-Shi (JP); Masaharu NAKAMURA, Yokkaichi-Shi (JP); Koichi KATO, Yokkaichi-Shi (JP)

(73) Assignee: Sumitomo Wiring Systems, Ltd., Yokkaichi-Shi (JP)

(21) Appl. No.: 18/894,256

(22) Filed: Sep. 24, 2024

(30) Foreign Application Priority Data
Sep. 28, 2023 (JP) 2023-167734

(51) Int. Cl. G01P 1/00; B29C 70/68; B29C 70/72; B29C 70/84; B29C 70/88; B29L 31/34; G01P 3/481

(52) U.S. Cl. CPC G01P 1/00; B29C 70/682; B29C 70/72; B29C 70/84; B29C 70/885; G01P 3/481; B29L 2031/3481

(57) ABSTRACT

Provided is a sensor member that can be easily manufactured even with different specifications. A sensor member includes a sensor, a wire member connected to the sensor, a fixing bracket, and a resin molded member molded as a single body with the fixing bracket and covering the sensor and a portion of the wire member drawn out from the sensor. The resin molded member includes a primary molded part covering the sensor and the portion of the wire member drawn out from the sensor, and a secondary molded part molded with the primary molded part and the fixing bracket as insert parts.

### CROSS-REFERENCE TO RELATED APPLICATIONS

This application claims priority of Japanese Patent Application No. JP 2023-167734 filed on Sep. 28, 2023, the contents of which are incorporated herein.

### TECHNICAL FIELD

The present disclosure relates to a sensor member and a method for manufacturing a sensor member.

### BACKGROUND

Conventionally, a sensor member such as a wheel speed sensor includes a sensor, a wire member connected to the sensor, a fixing bracket, and a resin molded member molded with these components as insert parts (e.g., see JP 2015-141129A). The resin molded member is molded as a single body with the fixing bracket and covers the sensor and a portion of the wire member drawn out from the sensor. In such a sensor member, for example, the fixing bracket is fixed to a vehicle, and the sensor detects rotation of a wheel.

JP 2015-141129A is an example of related art.

### SUMMARY

However, the specifications of fixing brackets for the sensor member described above may differ from each other depending on, for example, the type of vehicle to which the sensor member is fixed. Thus, for example, a large mold for molding a resin molded member having a large size needs to be produced for each specification. This causes, for example, an increase in manufacturing costs.

The present disclosure aims to provide a sensor member that can be easily manufactured even with different specifications, and a method for manufacturing the sensor member.

A sensor member according to the present disclosure includes a sensor, a wire member connected to the sensor, a fixing bracket, and a resin molded member molded as a single body with the fixing bracket and covering the sensor and a portion of the wire member drawn out from the sensor, in which the resin molded member includes a primary molded part covering the sensor and the portion of the wire member drawn out from the sensor, and a secondary molded part molded with the primary molded part and the fixing bracket as insert parts.

According to the sensor member and the method for manufacturing a sensor member of the present disclosure, it is possible to easily manufacture sensor members even when the sensor members have different specifications.

### BRIEF DESCRIPTION OF THE DRAWINGS

FIG. 1 is a perspective view of a sensor member according to an embodiment;

FIG. 2 is a side view of the sensor member according to an embodiment;

FIG. 3 is a side view of a portion of a primary molded part according to an embodiment;

FIG. 4 is a perspective view of a portion of the primary molded part according to an embodiment; and

FIG. 5 is a cross-sectional perspective view of a portion of the primary molded part according to an embodiment.

### DETAILED DESCRIPTION OF PREFERRED EMBODIMENTS

First, embodiments of the present disclosure will be listed and described.

In a first aspect, a sensor member according to the present disclosure is a sensor member including: a sensor; a wire member connected to the sensor; a fixing bracket; and a resin molded member molded as a single body with the fixing bracket and covering the sensor and a portion of the wire member drawn out from the sensor, in which the resin molded member includes a primary molded part covering the sensor and the portion of the wire member drawn out from the sensor, and a secondary molded part molded with the primary molded part and the fixing bracket as insert parts.

With this configuration, because the resin molded member includes the primary molded part covering the sensor and a portion of the wire member, and a secondary molded part molded with the primary molded part and the fixing bracket as insert parts, it is possible to easily obtain sensor members having different specifications using the primary molded part as a common component. That is, the specifications of fixing brackets for a sensor member may differ from each other depending on, for example, the type of vehicle to which the sensor member is fixed. Also, for example, by producing the primary molded part as a common component, parts having different specifications can be handled with only a change in a small mold. Thus, it is possible to easily manufacture sensor members having different specifications. As a result, for example, it is possible to reduce manufacturing costs.

In a second aspect according to the first aspect, the fixing bracket may have a through hole through which the secondary molded part passes, and the secondary molded part may include a bent lead-out portion that bends outside the through hole and leads out the wire member.

With this configuration, because the secondary molded part includes the bent lead-out portion that bends outside the through hole of the fixing bracket and leads out the wire member, it is possible to stably draw out the wire member in a direction intersecting with the axis of the through hole, and to achieve a thickness reduction in a direction in which the axis of the through hole extends. As a result, for example, it is possible to stably inhibit the wire member from coming into contact with other members. That is, for example, when the space of a mounting object to which the sensor member is to be mounted is small in the direction in which the axis of the through hole extends, or the like, the sensor member can be mounted such that the wire member does not come into contact with the mounting object.

In a third aspect, the fixing bracket according to the second aspect may be plate-shaped and have a fixing hole extending through the fixing bracket in parallel to the through hole, and may have a lead-out recess recessed such that at least a portion of the bent lead-out portion is embedded therein.

With this configuration, because the fixing bracket is plate-shaped, has the fixing hole extending through the fixing bracket in parallel to the through hole, and has the lead-out recess recessed such that at least a portion of the bent lead-out portion is embedded therein, it is possible to further achieve a thickness reduction in the direction in which the axis of the through hole extends.

In a fourth aspect, in accordance with any one of the first through the third aspects, the primary molded part may have a connection portion connecting to the secondary molded part, and the connection portion may have a rotation preventing portion at a portion in a circumferential direction of the connection portion.

With this configuration, because the primary molded part has the connection portion connecting to the secondary molded part, and the connection portion has the rotation preventing portion at a portion in a circumferential direction of the connection portion, thus preventing the primary molded part from rotating relative to the secondary molded part.

In a fifth aspect, a method for manufacturing a sensor member according to the present disclosure is a method for manufacturing a sensor member, the sensor member including: a sensor, a wire member connected to the sensor, a fixing bracket, and a resin molded member molded as a single body with the fixing bracket and covering the sensor and a portion of the wire member drawn out from the sensor, the method including a first molding step of molding a primary molded part, the primary molded part being a portion of the resin molded member covering the sensor and the portion of the wire member drawn out from the sensor; and a second molding step of molding a secondary molded part, the secondary molded part being a portion of the resin molded member, with the primary molded part and the fixing bracket as insert parts.

With this method, because the resin molded member includes the primary molded part covering the sensor and a portion of the wire member, and a secondary molded part molded with the primary molded part and the fixing bracket as insert parts, it is possible to easily obtain sensor members having different specifications using the primary molded part as a common component. That is, the specifications of fixing brackets for a sensor member may differ from each other depending on, for example, the type of vehicle to which the sensor member is fixed. Also, for example, by producing the primary molded part as a common component in the first molding step, parts having different specifications can be handled in the second molding step with only a change in a small mold. Thus, it is possible to easily manufacture sensor members having different specifications. As a result, for example, it is possible to reduce manufacturing costs.

In a sixth aspect in accordance with the fifth aspect, the primary molded part may have a connection portion connecting to the secondary molded part, and a melt rib that is to melt in the second molding step may be molded around the connection portion in the first molding step.

With this method, because the primary molded part has the connection portion connecting to the secondary molded part, and the melt rib that is to melt in the second molding step is molded around the connection portion in the first molding step, the primary molded part and the secondary molded part can be firmly connected to each other. Also, it is possible to ensure high waterproofness at the boundary between the primary molded part and the secondary molded part.

Specific examples of the sensor member according to the present disclosure will be described below with reference to the drawings. Portions of configurations may be exaggerated or simplified in the diagrams for convenience in the description. In addition, the ratios between the dimensions shown in the diagrams may be different from each other. Being “parallel”, “orthogonal”, or “perfectly circular” as used herein includes not only being strictly parallel, orthogonal, or perfectly circular, but also being generally parallel or orthogonal, as long as functional effects of this embodiment can be achieved. Note that the present disclosure is not limited to these examples, and is defined by the claims, and all changes that come within the meaning and range of equivalency of the claims are intended to be embraced therein.

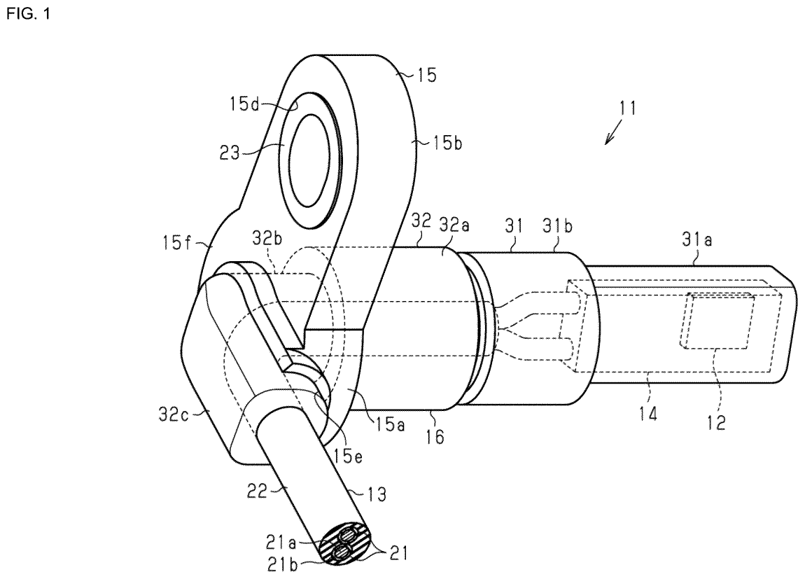

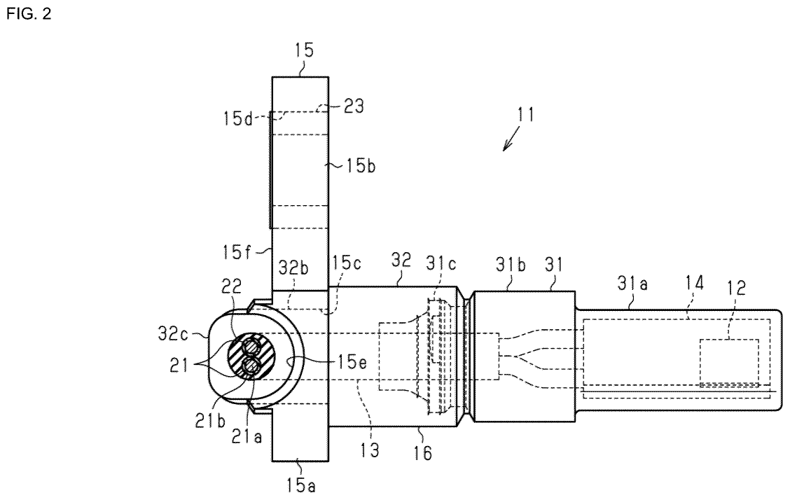

As shown in FIGS. 1 and 2, the sensor member 11 includes a sensor 12, a wire member 13, a sensor holder 14, a fixing bracket 15, and a resin molded member 16. The sensor member 11 in this embodiment is, for example, a wheel speed sensor in which the fixing bracket 15 is fixed to a vehicle and the sensor 12 detects rotation of a wheel.

The sensor 12 is a rotation detection sensor capable of detecting a change in a magnetic field based on the rotation of a wheel, and employs, for example, a square plate-shaped Hall IC.

The wire member 13 has two wires 21 and an exterior member 22. The wires 21 each include a conductive core wire 21a and an insulating sheath 21b that surrounds an outer circumference of the core wire 21a and has insulating properties. The exterior member 22 is, for example, made of a flexible material such as urethane, and covers the two wires 21 while bundling the wires 21 together. Also, the wire member 13 is connected to the sensor 12. Specifically, end portions of the two wires 21 are exposed to the outside of the exterior member 22, and the core wires 21a of the two wires 21 are connected to the sensor 12.

The sensor holder 14 is made of a resin material. The sensor holder 14 holds the sensor 12. Also, the sensor holder 14 maintains a connection state in which the core wires 21a of the two wires 21 and the sensor 12 are connected to each other.

The fixing bracket 15 is made of a resin material. The fixing bracket 15 is plate-shaped. The fixing bracket 15 includes a disk-shaped sensor fixing portion 15a, and an external fixing portion 15b protruding outward from a portion of an outer circumference of the sensor fixing portion 15a.

Also, as shown in FIG. 2, the sensor fixing portion 15a has a through hole 15c. The through hole 15c extends through the sensor fixing portion 15a along the axis of the fixing bracket 15 in its thickness direction. The through hole 15c is formed at the center of the sensor fixing portion 15a. Also, the external fixing portion 15b has a fixing hole 15d extending through the fixing bracket in parallel to the through hole 15c. A tubular metal collar 23 is provided on the inner surface of the fixing hole 15d.

Further, the sensor fixing portion 15a has a lead-out recess 15e extending from an opening end of the through hole 15c to an outer edge of the sensor fixing portion 15a. The lead-out recess 15e is recessed into one main surface 15f of the plate-shaped fixing bracket 15. In other words, the plate-shaped fixing bracket 15 is formed such that a portion where the lead-out recess 15e is formed is thinner than the other portion. The lead-out recess 15e has an arc-shaped cross section orthogonal to the direction in which the lead-out recess 15e extends.

The resin molded member 16 is made of a resin material. The resin molded member 16 is molded as a single body with the fixing bracket 15 while covering the sensor 12, the sensor holder 14, and a portion of the wire member 13 drawn out from the sensor 12. That is, the fixing bracket 15 and the resin molded member 16 are integrally molded in the completed sensor member 11.

Also, the resin molded member 16 includes a primary molded part 31 covering the sensor 12, the sensor holder 14, and the portion of the wire member 13 drawn out from the sensor 12, and a secondary molded part 32 molded with the primary molded part 31 and the fixing bracket 15 as insert parts.

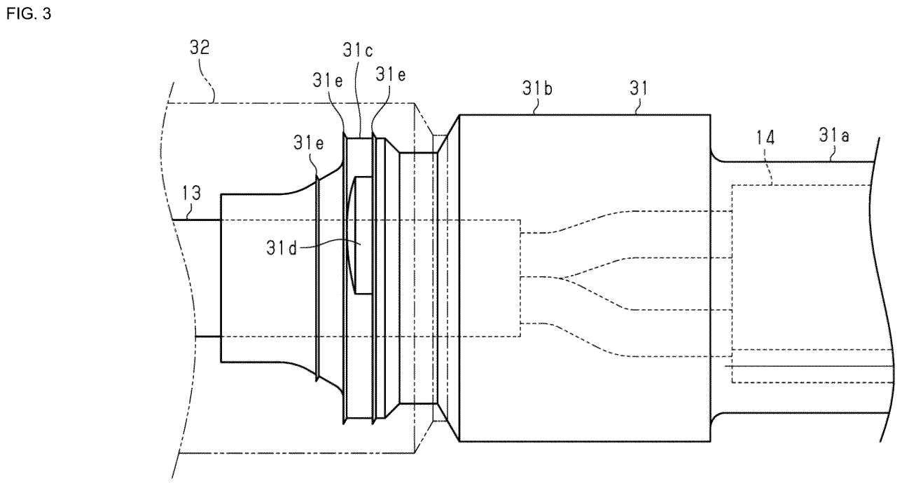

Specifically, as shown in FIG. 3, the primary molded part 31 is configured such that a quadrangular prism-shaped leading end portion 31a, a round columnar intermediate portion 31b, and a round columnar connection portion 31c having a smaller diameter than the intermediate portion 31b are continuously arranged in this order on a straight line.

The leading end portion 31a covers the sensor holder 14 including the sensor 12. The intermediate portion 31b and the connection portion 31c cover a portion of the wire member 13 drawn out from the sensor 12. The wire member 13 extends while protruding outward from the end portion of the connection portion 31c.

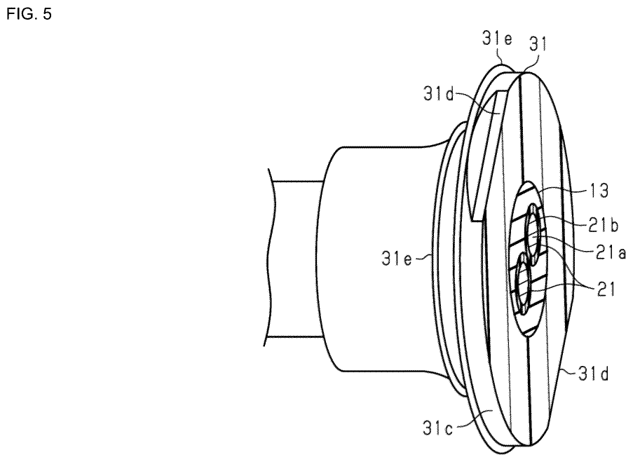

Also, as shown in FIGS. 3 to 5, the connection portion 31c has a rotation preventing portion 31d at a portion in the circumferential direction. Specifically, the connection portion 31c is a portion connected to the secondary molded part 32 when molding the secondary molded part 32 (see FIG. 3). Also, the rotation preventing portion 31d has a shape that allows engagement in the circumferential direction to prevent the primary molded part 31 from rotating relative to the secondary molded part 32. Two rotation preventing portions 31d of this embodiment are provided at equal intervals on the outer circumferential surface of the connection portion 31c. Each rotation preventing portion 31d is a flat surface formed by removing a portion of the outer circumference of the round columnar connection portion 31c. The two rotation preventing portions 31d are formed parallel to each other.

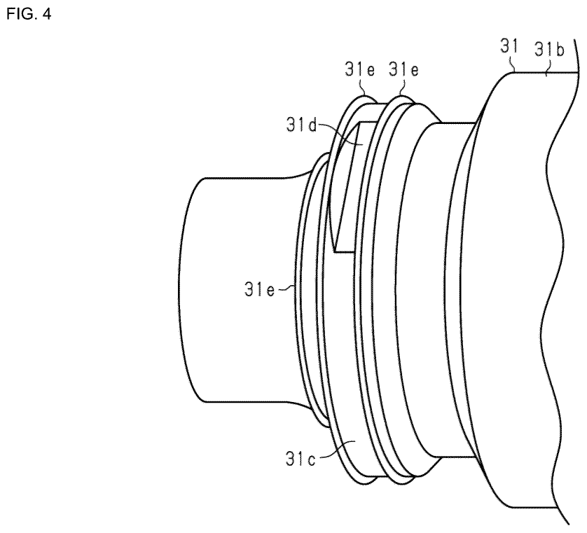

Also, as shown in FIGS. 3 and 4, the connection portion 31c has melt ribs 31e on its periphery in a state before the secondary molded part 32 is molded. The melt ribs 31e are provided on the entire outer circumferential surface of the connection portion 31c. That is, each melt rib 31e is provided in an annular shape. The melt rib 31e is a thin protruding part to melt when the secondary molded part 32 is molded. Three melt ribs 31e are provided at intervals on the connection portion 31c. The two melt ribs 31e are provided at positions to sandwich the rotation preventing portions 31d.

As shown in FIGS. 1 and 2, the secondary molded part 32 includes a round columnar secondary connection portion 32a, a round columnar through portion 32b that continuously extends from the secondary connection portion 32a and whose diameter is smaller than that of the secondary connection portion 32a, and a bent lead-out portion 32c bending and extending from the through portion 32b.

The secondary connection portion 32a is molded with the primary molded part 31 as an insert part, and thus is connected to the connection portion 31c while covering the connection portion 31c of the primary molded part 31 and a portion of the wire member 13 that protrudes from the connection portion 31c.

The through portion 32b is filled into the inside of the through hole 15c of the fixing bracket 15, and thus extends through the through hole 15c while covering the portion of the wire member 13. Also, the bent lead-out portion 32c is bent and extends outside the through hole 15c while covering the portion of the wire member 13. Further, the wire member 13 is lead out from a leading end of the bent lead-out portion 32c. Also, the bent lead-out portion 32c is arranged such that a portion of the bent lead-out portion 32c is embedded in the lead-out recess 15e.

The sensor member 11 configured as described above is attached to a vehicle via the fixing bracket 15. The sensor member 11 of this embodiment is attached to a position near a wheel of the vehicle by a bolt (not shown) or the like, which passes through the fixing hole 15d, specifically, the metal collar 23.

Next, a method for manufacturing the sensor member 11 configured as described above will be described.

The method for manufacturing the sensor member 11 includes a preprocessing step, a first molding step, and a second molding step. In the preprocessing step, a member in which the sensor 12, the wire member 13, and the sensor holder 14 are assembled, and a fixing bracket 15 are prepared.

Also, then, in the first molding step, the primary molded part 31 covering the sensor 12, the sensor holder 14, and the portion of the wire member 13 drawn out from the sensor 12 is molded. That is, in the first molding step, the primary molded part 31 is molded by filling a mold (not shown) with a resin melt in a state in which the member, in which the sensor 12, the wire member 13, and the sensor holder 14 are assembled, is disposed as an insert part in the mold. In the first molding step, a melt rib 31e (see FIGS. 3 and 4) that is to melt in the second molding step is molded around the connection portion 31c.

Then, in the second molding step, the secondary molded part 32 is molded with the primary molded part 31 and the fixing bracket 15 as insert parts. That is, in the second molding step, the secondary molded part 32 is molded by filling a mold (not shown) with a resin melt in a state in which the primary molded part 31 and the fixing bracket 15 are disposed as insert parts in the mold. Manufacturing of the sensor member 11 is completed in this manner.

Next, effects of the above embodiment will be described below.

The resin molded member 16 includes the primary molded part 31 covering the sensor 12, the sensor holder 14, and the portion of the wire member 13 drawn out from the sensor 12, and the secondary molded part 32 molded with the primary molded part 31 and the fixing bracket 15 as insert parts. Thus, it is possible to easily manufacture the sensor members 11 having different specifications using the primary molded part 31 as a common part. That is, the specifications of fixing brackets 15 for the sensor member 11 may differ from each other depending on, for example, the type of vehicle to which the sensor member 11 is fixed. Also, for example, by producing the primary molded part 31 as a common part, parts having different specifications can be handled with only a change in a small mold. Thus, it is possible to easily manufacture sensor members 11 having different specifications. As a result, for example, it is possible to reduce manufacturing costs.

The secondary molded part 32 includes the bent lead-out portion 32c that bends outside the through hole 15c of the fixing bracket 15 and leads out the wire member 13. Therefore, it is possible to stably draw out the wire member 13 in a direction intersecting with the axis of the through hole 15c, and to achieve a thickness reduction in a direction in which the axis of the through hole 15c extends. As a result, for example, it is possible to stably inhibit the wire member 13 from coming into contact with other members. That is, for example, when the space of a mounting object to which the sensor member 11 is to be mounted is small in the direction in which the axis of the through hole 15c extends, or the like, the sensor member 11 can be mounted such that the wire member 13 does not come into contact with the mounting object.

The fixing bracket 15 is plate-shaped and has the fixing hole 15d extending through the fixing bracket 15 in parallel to the through hole 15c, and has a lead-out recess 15e recessed such that at least a portion of the bent lead-out portion 32c is embedded therein. Thus, it is possible to further achieve a thickness reduction in a direction in which the axis of the through hole 15c extends.

Because the primary molded part 31 has a connection portion 31c connecting to the secondary molded part 32, and the connection portion 31c has the rotation preventing portions 31d at portions in the circumferential direction of the connection portion 31c, thus preventing the primary molded part 31 from rotating relative to the secondary molded part 32.

The primary molded part 31 has the connection portion 31c connecting to the secondary molded part 32, and the melt ribs 31e that are to melt in the second molding step are molded around the connection portion 31c in the first molding step. Therefore, the primary molded part 31 and the secondary molded part 32 can be firmly connected to each other. Also, it is possible to ensure high waterproofness at the boundary between the primary molded part 31 and the secondary molded part 32.

This embodiment can be modified and implemented as follows. This embodiment and the following modification examples may be combined and implemented to the extent that they do not contradict each other technically.

Although the secondary molded part 32 includes the bent lead-out portion 32c that bends outside the through hole 15c of the fixing bracket 15 and leads out the wire member 13 in the above embodiment, the secondary molded part 32 is not limited to this and may be configured to have a lead-out part that leads out the wire member 13 without bending. That is, the bent lead-out portion 32c may be changed to a lead-out part that extends in the direction in which the axis of the through hole 15c extends and leads out the wire member 13 in this direction, and the sensor member 11 having such a lead-out part with different specifications may be embodied.

Although the fixing bracket 15 has the lead-out recess 15e recessed such that at least a portion of the bent lead-out portion 32c is embedded therein in the above embodiment, the fixing bracket 15 is not limited to this and may be configured not to have the lead-out recess 15e.

Although the connection portion 31c of the primary molded part 31 has the rotation preventing portions 31d at portions in a circumferential direction of the connection portion 31c in the above embodiment, the connection portion 31c is not limited to this and may be modified not to have the rotation preventing portion 31d. Also, the number of rotation preventing portions 31d may be changed to another number. Further, the shape of the rotation preventing portion 31d may be changed to another shape.

Although the melt ribs 31e that are to melt in the second molding step are molded around the connection portion 31c in the first molding step in the above embodiment, the present disclosure is not limited to this, and the melt rib 31e does not need to be molded.

Although the wire member 13 has two wires 21 and the exterior member 22 in the above embodiment, the present disclosure is not limited to this, and the wire member 13 may be changed to a wire member having another configuration. For example, the wire member may have three or more wires 21. Also, for example, the wire member, which does not have the exterior member 22, may be used.

Although the sensor member 11 is a wheel speed sensor provided with the sensor 12 capable of detecting a change in a magnetic field based on the rotation of a wheel in the above embodiment, the sensor member 11 is not limited to this and may be embodied for other purposes.

1. A sensor member comprising:
a sensor;
a wire member connected to the sensor;
a fixing bracket; and
a resin molded member molded as a single body with the fixing bracket and covering the sensor and a portion of the wire member drawn out from the sensor,
wherein the resin molded member includes a primary molded part covering the sensor and the portion of the wire member drawn out from the sensor, and a secondary molded part molded with the primary molded part and the fixing bracket as insert parts.

2. The sensor member according to claim 1,
wherein the fixing bracket has a through hole through which the secondary molded part passes, and
the secondary molded part includes a bent lead-out portion that bends outside the through hole and leads out the wire member.

3. The sensor member according to claim 2,
wherein the fixing bracket is plate-shaped and has a fixing hole extending through the fixing bracket in parallel to the through hole, and has a lead-out recess recessed such that at least a portion of the bent lead-out portion is embedded therein.

4. The sensor member according to claim 1,
wherein the primary molded part has a connection portion connecting to the secondary molded part, and
the connection portion has a rotation preventing portion at a portion in a circumferential direction of the connection portion.

5. A method for manufacturing a sensor member, the sensor member including a sensor, a wire member connected to the sensor, a fixing bracket, and a resin molded member molded as a single body with the fixing bracket and covering the sensor and a portion of the wire member drawn out from the sensor, the method comprising:
a first molding step of molding a primary molded part, the primary molded part being a portion of the resin molded member covering the sensor and the portion of the wire member drawn out from the sensor; and
a second molding step of molding a secondary molded part, the secondary molded part being a portion of the resin molded member, with the primary molded part and the fixing bracket as insert parts.

6. The method for manufacturing a sensor member according to claim 5,
wherein the primary molded part has a connection portion connecting to the secondary molded part, and
in the first molding step, a melt rib that is to melt in the second molding step is molded around the connection portion.
